(19) United States
(12) Patent Application Publication
(10) Pub. No.: US 2007/0297274 A1
(43) Pub. Date: Dec. 27, 2007

(54) Food Contents Stirrer

(76) Inventor: John Ondracek, Denver, CO (US)

Correspondence Address: LEYENDECKER LEMIRE & DALEY, LLC, C/O PORTFOLIO IP, P.O. BOX 52050, MINNEAPOLIS, MN, 55402, US

(21) Appl. No.: 11/426,845

(22) Filed: Jun. 27, 2006

(51) Int. Cl. A47J 43/10

(52) U.S. Cl. 366/129; 366/312; 366/325.93; 366/328.4

(57) ABSTRACT

Current mixing devices do not allow partially-liquefied food contents to be adequately mixed while also thickening the mixture, without creating any burned portions of the mixture or creating any limp, tasteless, and lowered-nutrient solid items. Embodiments of the current invention allows mixture of food contents in a manner resulting in a thoroughly mixed substance that is adequately thick, while also minimizing the amount of limp, tasteless, and lowered-nutrient solid items. The embodiments comprise a handle, a stem, and at least one stirrer blade, with the stirrer blade comprising a mesh surface, at least one v-shaped edge adapted to dislodge portions of the mixture fixedly attached to the inner surface of the cookware. The embodiments are adapted to be used in a method designed to adequately mix and thicken the food contents.

### FIELD OF THE INVENTION

This invention relates generally to food content mixing devices.

### BACKGROUND

Cooking involves the preparation of food for consumption. It encompasses a vast range of methods, tools and combinations of ingredients typically designed to improve the flavor or digestibility of food. Cooking generally requires the selection, measurement and combination of ingredients in an ordered procedure, typically called a recipe, in an effort to achieve a desired result. Many times, this procedure requires mixing the ingredients during the cooking process. Constraints on success in achieving the desired result include ingredient variability, any unknown ambient conditions, skill of the individual or individuals involved in cooking the food, and the tools and methods used by such individuals.

A requirement of cooking is the application of heat to the ingredients. Many times, though not always, applying heat to food chemically transforms the properties of the food, changing its flavor, texture, appearance, and nutritional value. In using heat to change the properties of ingredients while creating a partially liquefied meal such as sauces, stews, and soups, care must be taken to ensure the ingredients create the optimal edible result. For example, in items such as stews, soups, and sauces, solid food ingredients (for example, bell peppers) that are many times contained therein may become limp, tasteless, and the nutritional value of such items may decrease if care is not taken in monitoring the cooking process.

Many times, the unwanted textures, tastes, and nutritional value decrease comes about from the need to cook sauces, stews, and soups for a longer period of time than the recipe calls for. The reason that these items must many times be cooked for longer periods than what is originally thought to be necessary is because many times stews, sauces, and soups must be thickened to achieve the particular user's desired result, and thickening, whether through reduction or by adding a thickening agent to the liquid, typically requires a longer cooking time.

In reduction, thickening occurs through evaporation of the liquid that occurs when extending the cooking time. More often, however, an agent such as flour, a roux, or buerre manié (a dough consisting of equal parts butter and flour) is added to the mixture. To ensure that the agent is adequately dissolved in the mixture, or, during reduction, to ensure that the mixture is uniformly thickened, the mixture is typically stirred while heat is applied to the mixture. Therefore, if the agent does not dissolve in the amount of time required by the recipe, or if the liquid does not evaporate quick enough to create an adequately thick mixture, the liquid continues to be cooked for long periods of time. This additional cooking, in order to thicken the liquid, may create the limp and tasteless solid items in the liquid.

In addition to the problem of overcooking solid items, the liquid itself may burn near the bottom and sides of the cookware due to the excessive heat being supplied to the liquid for a period longer than that required by the recipe. When this occurs, the liquid evaporates, and the solid items and particulates therein may become hardened, consisting of a black, brittle substance. If only a small amount of the substance is burned, the unburned part of the liquid is typically separated from the burned part or parts, and able to be used in the meal. However, if a large amount of the substance is burned, the liquid and items therein may become inedible, thereby creating a completely unusable substance. Burning creates a waste of time, money, and energy.

Limitations in the mixing spoon and other prior art devices, such as U.S. Pat. Nos. 3,691,938 and 4,151,792, do not allow for cooking ingredients to be properly mixed in creating thick sauces, stews, and soups. Prior art devices to not ensure creation of appropriately think sauces, stews, and soups, while also ensuring that the liquids are not burned and do not contain limp and tasteless items therein.

### BRIEF DESCRIPTION OF THE DRAWINGS

FIG. 1 is an isometric view of a food contents stirrer according to one embodiment of the current invention.

FIG. 2A is an isometric view of a food contents stirrer blade according to one embodiment of the current invention.

FIG. 2B is a close-up cut-away of a section of a food contents stirrer blade according to one embodiment of the current invention.

FIG. 3 is an isometric view of a food contents stirrer handle and stem according to one embodiment of the current invention

FIG. 4 is a top view of a food contents stirrer handle according to one embodiment of the current invention.

FIG. 5 is a side view of a food contents stirrer handle and stem according to one embodiment of the current invention.

FIG. 6 is a cross-sectional side view of a stirrer blade according to one embodiment of the current invention.

FIG. 7 is a cross-sectional top view of an integrated stirrer blade according to one embodiment of the current invention.

FIG. 8 is a cross-sectional top view of a food contents stirrer stem adapted to be coupled to a stirrer blade according to one embodiment of the current invention.

FIG. 9 is a cross-sectional top view of a stirrer blade adapted to be coupled to a stirrer stem according to one embodiment of the current invention.

FIG. 10 is an isometric view of a stirrer blade adapted to be coupled to a stirrer stem according to a second embodiment of the current invention.

FIG. 11 is an isometric view of a food contents stirrer and cookware illustrating a stirring method according to one method of the current invention.

### DETAILED DESCRIPTION

One embodiment of the current invention contemplates a stirrer comprising a plurality of stirrer blades having mesh surfaces, each blade also typically having two generally v-shaped edges. The stirrer is typically used to mix food contents such as stews, soups, and various kinds of sauces, including gravy. In the typical embodiment, the stirrer also includes a handle and stem, the handle being used to hold the stirrer while stirring the food contents. The stem typically couples the handle to the stirrer blades.

In the current embodiment, after ingredients are placed within cookware and heated, the user grips the stirrer handle and places the stirrer into the food contents. At least one of the generally v-shaped edges is placed generally flush against the inner bottom surface of the cookware containing the food contents. A second v-shaped edge is placed generally flush against an inner side surface of the cookware. As pressure is applied to each of these two edges, the user begins to move the stirrer around the cookware.

In order to mix the food contents in a manner minimizing the amount of limp, tasteless, and lower nutrient solid items and to minimize the amount of burned mixture portions, while at the same time maximizing the rate at which the liquid is thickened and adequately mixed, a counter-clockwise motion is initially used to stir the contents. As the stirrer moves through the mixture and around the cookware, throughout the entire counter-clockwise rotation, at least one of the v-shaped edges is substantially continually placed against the inner bottom surface of the cookware and at least one of the v-shaped edges is substantially continually placed against the inner side surface of the cookware.

Upon completion of one counter-clockwise rotation, a first figure-8 rotation is introduced to the stirring method. During the first figure-8 rotation, the v-shaped edge that is placed against the inner bottom surface of the cookware is continued to be placed against the inner bottom surface of the cookware substantially throughout the first figure-8 rotation. However, the v-shaped edge that is placed against the inner side surface of the cookware is not continued to be placed against the inner side surface of the cookware throughout the first figure-8 rotation.

Upon reaching the end of the first figure-8 rotation, the counter-clockwise rotation is begun once again and alternated with the first figure-8 rotation until the liquid is adequately thickened and mixed. When the liquid is adequately thickened and mixed, the stirrer is removed from the liquid via the handle and the cookware is removed from the heat source. During the thickening and mixing process, a clockwise rotation or a second figure-8 rotation may be used instead of the counter-clockwise or the first figure-8 rotation, respectively. The second figure-8 rotation generally mirrors the first figure-8 rotation.

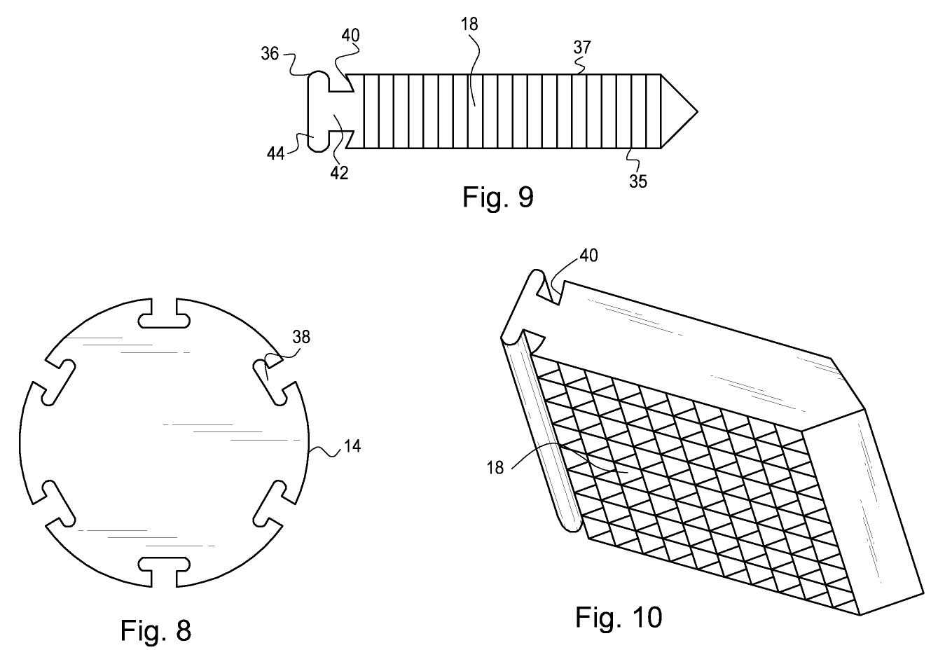

Through combining a stirrer embodiment comprising a plurality of mesh surfaces, each mesh surface typically having two generally v-shaped edges, with a mixing/thickening method which includes a counter-clockwise/clockwise and first figure 8/second figure 8 stirring method, the partially liquefied food contents are typically mixed and thickened before any burning occurs or limp, tasteless, and lowered nutrient solid items are created. The mesh surfaces break up any lumps of thickening agent within the mixture better than prior art devices when a thickening agent is used and keeps the liquid mixed better than prior art devices such as when reduction is used to thicken sauces, soups, and stews. These food items are therefore better and more efficiently mixed with a mesh surface than if they are mixed with prior art devices.

As stated, besides the stirrer blade mesh surfaces, the additional features that create better soups, stews, and sauces, including gravy, are the v-shaped edges and the stirring motion. The v-shaped edges scrape the inside edges of the cookware, thereby reducing any mixture build-up on the inside surface of the cookware and limiting the amount of mixture that becomes burned. Prior art does not scrape the inside surfaces of the cookware. Lastly, by using a circular motion together with a figure 8 motion, the entire mixture is mixed in a manner that creates a more equal distribution of heat throughout the mixture, creating a more thoroughly mixed and more evenly thickened mixture than prior art devices.

### Terminology:

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

References to a “v-shaped edge” or to “v-shaped edges” refer to the outer and bottom surfaces of each stirrer blade.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied.

The term “integrate” or “integrated” as used in this specification and the appended claims refers to a blending, uniting, or incorporation of the identified elements, components or objects into a unified whole.

### One Embodiment of a Food Contents Stirrer:

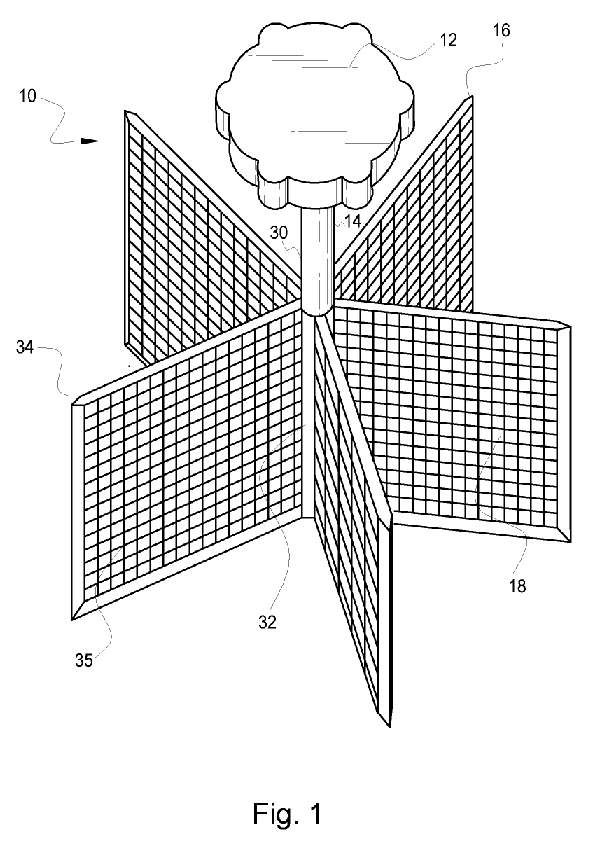

Referring to FIGS. 1 through 10, an embodiment of a food contents stirrer 10 is illustrated. The current embodiment comprises a handle 12, a stem 14, and at least one stirrer blade 16. In the current embodiment, the handle is typically integrated to the stem. The stem is also typically integrated to one or more stirrer blades. However, in alternative embodiments, the stem is coupled to the handle and the one or more stirrer blades. The one or more stirrer blades are each comprised of at least one mesh interior 18 and at least one generally v-shaped edge 31.

The handle 12 in the current embodiment is typically a twist-style handle, being generally cylindrically-shaped, as best shown in FIGS. 4 and 5. The handle typically has a general circular cross-section, with the edge of the circular cylinder being a ridged edge. The inner diameter 22 of the circular cross-section is typically greater than the length of the cylinder, thereby typically creating a “short” cylindrical handle. The handle may have another cross-sectional design, such as, but not limited to, a generally oval-shaped or rectangularly-shaped cross-section.

In the handle 12 having a cross-sectional design that is generally a ridged circle, the ridges in the handle edge are generally smooth ridges, although the ridges may be beveled ridges or may even be generally ridges having straight edges. Typically, the ridges are generally of equal size and shape and are generally equally spaced apart on the edge. The circumferential length 21 of each non-ridged portion of the generally circular cross-section edge is typically, in general, equal to the circumferential length 23 of each ridged portion. Therefore, there are typically an equal number of ridged and non-ridged portions on the edge of the ridged handle of the current embodiment.

In alternative embodiments, the non-ridged portions of the edge of a ridged handle 12 are not equal in circumferential length to the ridged portions. In such a design, or in other designs, there are typically unequal numbers of ridged and nonridged portions of the handle edge. Whatever the design and number of the ridges on the edge of the handle, it is to be appreciated that the purpose of the handle ridges is to provide a user with a more stable grip on the food contents stirrer 10 than a non-ridged handle would provide.

In addition to typically being a generally circular ridged-edged handle 12, the size of the inner diameter 22 and the handle ridges are typically such that the handle allows a user to grip the stirrer 10 with an adequately stable grip. An adequately stable grip is typically a grip that allows a user to apply a generally constant pressure to the inside of the cookware from the stirrer blades 16 while stirring the food contents. A generally circular handle may have an inner diameter as small as ½ an inch in some instances and as large as 4 inches in other instances. The typical inner diameter of a generally circular ridged edge handle is generally 2 inches.

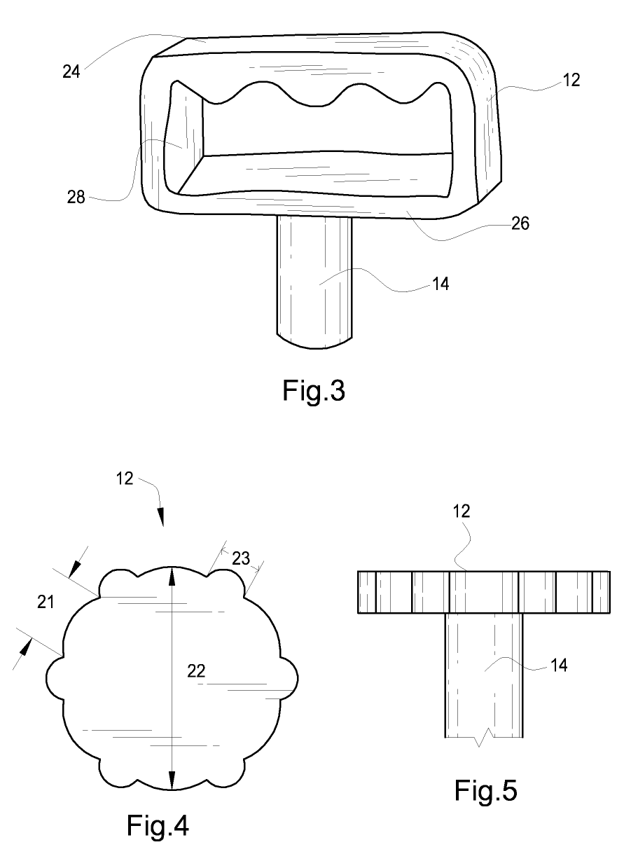

As opposed to a cylindrically-shaped, twist-style handles, in alternative embodiments, the handle 12 may be a different style of handle such as, but not limited to, a longitudinally-shaped pull-style handle, as best illustrated in FIG. 3. A pull-style handle may be used to allow a user to grip the food contents stirrer 10 with a more stable grip. As with a twist-style handle, a typical pull-style handle would also be integrated to the stem 14. The pull-style handle may be designed with an upper section 24, a lower section 26, and at least one connecting section 28. However, any other type of pull-style handle may be used. For example, other pull-style handles such as, but not limited to, handles comprising only an upper section may be used. These pull-style handles, when combined with the stem, generally create a “T” shape.

The connecting section 28 in a pull-style handle is typically at least 1 inch in length to allow a user to place the user's fingers between the upper section 24 and the lower section 26 in order to grip the handle 12. The upper and lower sections are typically the same length, the length being a length such as, but not limited to, 4 inches. Many times, the upper section will contain a ridged edge. The ridged edge is often the bottom surface of the top section in order to provide the user with a higher stability grip. The connection section, the upper section, and the lower section are typically the same width and thickness, with the width being typically generally 1 inch and the thickness being typically ¼ inch. However, a different thickness and width may be used.

The stem 14 of the current embodiment is generally a cylindrically-shaped stem. The stem is typically integrated to the handle 12. The stem and the handle may be integrated through a method such as, but not limited to, a molded assembly, although alternative embodiments may be comprised of a different integration method. Additionally, in alternative embodiments, the handle is not integrated to the stem, but may be coupled to the stem. The stem may be coupled to the handle by a mechanism such as, but not limited to, a bolt. In a bolted stem-handle embodiment, a threaded bolt typically extends longitudinally from the stem. In such an embodiment, the handle typically comprises a threaded recess adapted to receive the threaded bolt therein. Additional stem-handle coupling mechanisms in alternative embodiments may be mechanisms such as, but not limited to, latch mechanisms or adhesive mechanisms.

The stem is typically integrated to the handle 12 at a handle bottom surface. In a generally circularly-shaped cylindrical handle, or any other cross-sectionally shaped cylindrical handle, the stem is typically integrated generally to the center of the handle bottom surface. In the typical pull-handle design comprising an upper section 24, a lower section 26, and at least one connecting section 28, the stem is integrated to the bottom surface of the handle lower section, generally in the center of the bottom surface.

As opposed to the handle 12 having an inner diameter 22 typically larger than the length of the handle, the length of the stem 14 is generally greater than the diameter of the stem, when the stem is of a generally circular cross-section. If the stem is of any other cross-sectional geometry, such as, but not limited to, a rectangular cross-section, the length of the stem is typically longer than the size of one of the sides of the cross-section. In a circular cross-sectional stem, the typical stem diameter may be as large as 6 inches or as small as ¼ of an inch. However, the typical diameter is generally about 1 inch. In a stem that is of a different geometry than a circular cross-section, such as, but not limited to, a rectangular cross-section, the length of a side of a rectangular cross-section may be a length of generally 1 inch. In a stem of any cross-sectional geometry, the length of the stem may be as small as 3 inches and as great as 36 inches. A typical stirrer has a stem length generally about 10 inches.

The stem 14 typically comprises an upper portion 30 and a lower portion 32 as best shown in FIG. 1. The upper portion typically extends from the handle 12 to the top surface 34 of the one or more stirrer blades 16. The bottom portion is typically the portion of the stem that the stirrer blades are integrated or coupled to. The bottom portion typically extends from the top surface of the one or more stirrer blades to a stem distal end. Both the top portion and the bottom portion of the stem typically, although not necessarily, have substantially similar cross-sectional geometries. For example, if the upper portion is a generally circular cross-sectional stem, the bottom portion is also a generally circular cross-sectional stem, the upper portion and the bottom portion being of substantially similar diameters.

Although the stirrer blades 16 are typically integrated to the stem bottom portion 32, as stated, in alternative embodiments, the stirrer blades are coupled to the stem bottom portion. The stirrer blades may be coupled to the stem bottom portion through a mechanism such as, but not limited to, a flange-slot assembly as best shown in FIGS. 8-10. In the typical flange-slot assembly, the stirrer blade is integrated to a flange 36. The stem bottom portion includes at least one slot 38. A typical bottom portion will be comprised of 6 slots. Each slot is typically adapted to receive one stirrer blade. However, in alternative embodiments, each slot may receive more than one stirrer blade.

The typical flange in the flange-slot alternative embodiment is typically integrated to a stirrer blade at a blade inner surface 40. The typical flange is comprised of a flange inner portion 42 and a flange outer portion 44. The flange inner portion is integrated to both the flange outer portion and the stirrer blade inner surface, while the flange outer portion is typically only integrated to the flange inner portion.

The width of the flange inner portion 42 is typically smaller than the width of the flange outer portion 44 and the width of the blade inner surface 40. The blade inner surface is typically as wide as the mesh interior 18. However, in alternative embodiments, the width of the flange inner portion is as wide as, or may even be wider, than the mesh interior. The width of the flange outer portion is typically generally as wide as the mesh interior. However, in alternative embodiments, the width of the flange outer portion may be wider than, or not as wide as, the blade mesh interior.

Whether the design of the flange 36 is comprised a flange inner portion 40 and a flange outer portion 44, or the design of the flange is any other flange design, the flange is adapted to couple the stirrer blade 16 to the stem 14. In order to couple the stirrer blade to the stem in a secure manner such that the stirrer blade does not become unwantingly uncoupled from the stem, the flange is typically kept coupled to the slot through friction between the flange surface and the slot surface. However, the flange/slot may also be comprised of a locking mechanism such as, but not limited to, a latch.

In the flange-slot mechanism coupling system, the slot 38 is correspondingly adapted to couple to a received stirrer blade flange 36. Each slot is comprised of a recessed portion of the edge of the stem bottom portion 32 and typically extends the length of the stem bottom portion. However, in alternative embodiments, the slot does not extend the length of the bottom portion, but extends less than the length of the bottom portion, or, the length of the slot may extend into the stem top portion 30. As each slot is adapted to receive at least one stirrer blade flange, the typical slot is comprised of slot outer portion and a slot inner portion. The slot inner portion is adapted to receive the flange outer portion 44 and the slot outer portion is adapted to receive flange inner portion 42. Therefore, the slot outer portion is typically of a smaller width than the slot inner portion (as the flange inner portion is typically of a smaller width than the flange outer portion).

The preferred embodiment is typically comprised of 6 stirrer blades 16. Each stirrer blade that is integrated to the stem bottom portion 32 is integrated at equal stem circumferential distances from adjacent stirrer blades. In the slot-flange embodiment, the stirrer blade slots 38 which extend the length of the stem bottom portion are also generally equally circumferentially spaced apart on the stem edge. The circumferential distance of the outer slot may be equal to ¼ Of an inch, although in alternative embodiments, the outer slot portion circumferential distance may be less than ¼ of an inch, or greater than ¼ of an inch. For example, the circumferential distance of the slot may be a distance such as, but not limited to, 1/16 of an inch or as great as 2 inches.

In the typical integrated embodiment, the inner surface 40 of the stirrer blade 16 is integrated to the stem 14, as shown in FIG. 1. The integration may occur through a single mold of the stem and stirrer blade, or the integration may occur through a different mechanism. The circumferential length of the inner surface of a stirrer blade is typically such that the total surface area of the stem bottom portion 32 that is taken up by the 6 stirrer blade inner surfaces is equal to the surface area not taken up by the 6 stirrer blade inner surfaces. In order for the surface area of the 6 stirrer blade inner surfaces to be equal to the surface area of the stem bottom portion not covered by the stirrer blade inner surfaces, the circumferential length of the inner stirrer blade surface is generally equal to the circumferential length of the stem bottom portion between each stirrer blade. However, in alternative embodiments, the aggregate of the circumferential length of the inner surfaces of the stirrer blades is not equal to the aggregate of the circumferential length of the edge of the stem not covered by the blade inner surface.

Besides the inner surface 40 of the stirrer blade 16 being different between the coupled stirrer blade and the integrated stirrer blade, there are no substantial differences between the coupled stirrer blade and the integrated stirrer blade. For example, in the both stirrer blade embodiments, the stirrer blades are generally rectangular. However, the stirrer blade may be comprised of a different geometrical shape.

Whatever the shape of the stirrer blade 16, the stirrer blade is typically comprised of a mesh interior 18. In the rectangularly-shaped blade, the blades are also comprised of an outer surface 20, an upper surface 34, a bottom surface 33, a back surface 35 and a front surface 37. The front surface and the back surface are typically comprised of the mesh interior.

In the current embodiment, the mesh interior 18, inner blade surface 40, and upper surface 34 are typically comprised of a generally heat-resistant material such as, but not limited to, a substantially rigid plastic. The mesh interior may be a detachable mesh interior, although in the typical embodiment, the mesh interior is integrated to the upper surface, bottom surface 33, back surface, 35 and front surface 37. When the mesh interior is a detachable mesh interior, the user may detach and attach mesh with larger or smaller spacing between the mesh throughout the cooking process.

In the typical embodiment, the outer surface 20 and the bottom surface 33 are comprised of an elastomeric material. The current embodiment's stem 14 and handle 12 are typically comprised of a substantially rigid heat-resistant plastic. However, alternative embodiments are comprised of a material other than a substantially rigid plastic or an elastomeric material, such as, but not limited to, a composite material.

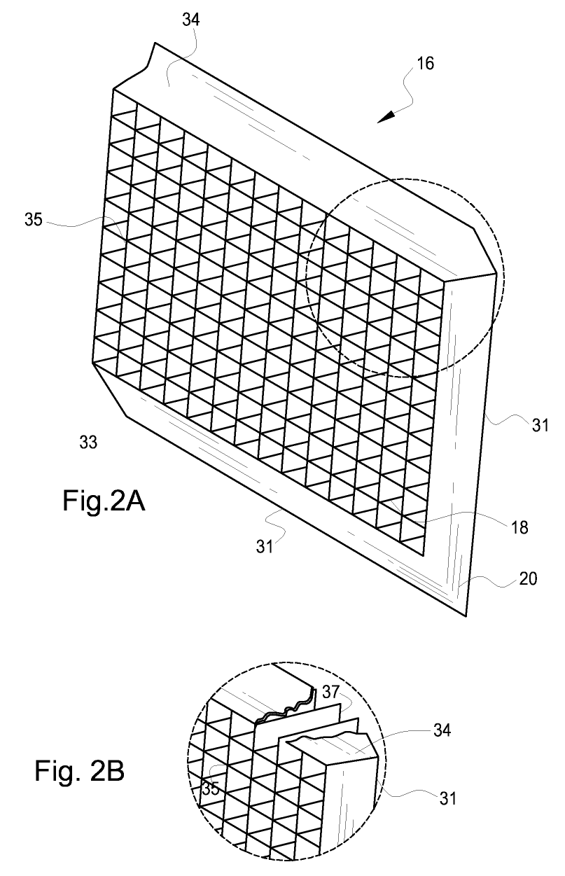

As shown in the cut-away of FIG. 2B, the mesh comprising the front surface 37 and the back surface 35 of each stirrer blade 16 is typically a single mesh. Therefore, the front surface mesh is typically extends to the back surface mesh. The mesh is typically a mesh having a thickness of 1/32 of an inch. However, in alternative embodiments, the mesh may be smaller or larger than 1/32 of an inch, such as, but not limited to, mesh that is 1/64 of an inch thick. In the particular embodiment, the mesh is spaced apart such that the spaces in the mesh are generally 1/16 of an inch square. However, in alternative embodiments, the spaces in between the mesh may be as large as one inch square or smaller than 1/16 of an inch square, such as, but not limited to, 1/32 of an inch square. It is to be appreciated that whatever the size of the mesh and the spaces between the mesh, the mesh is adapted to mix sauces, soups, and stews, including, but not limited to, gravy by allowing at least a portion of the mixture to pass between the mesh.

In the current embodiment, each mesh surface 18 is comprised of mesh that is typically evenly spaced. However, in alternative embodiments, the mesh nearest the inner stirrer blade surface 40 may be more densely spaced as compared to the mesh nearest the outer v-shaped edge 31, or vice versa. Also in the typical embodiment, the front mesh surface 37 and the back mesh surface 35 are generally flat surfaces. Therefore, in the present embodiment, the mesh is designed such that the mesh is generally parallel to the inner stirrer blade surface and generally perpendicular to the inner stirrer blade surface.

The top surface 34 of the stirrer blade 16 is a generally flat surface in the current embodiment. The top surface may be another mesh surface, or the top surface may be comprised of a smooth flat surface instead of a mesh surface. The top surface may also be comprised of a partially mesh and partially smooth surface.

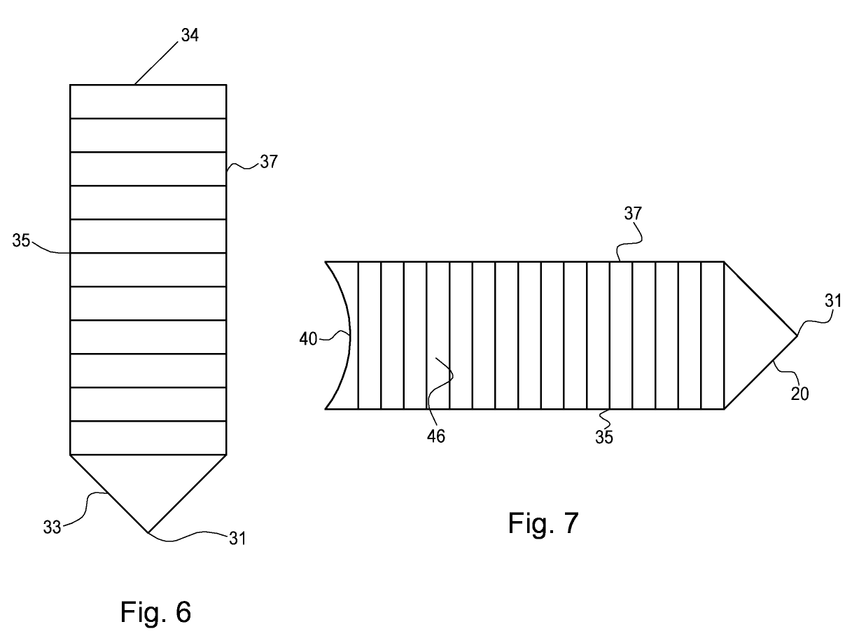

As best shown in FIGS. 6 and 7, the outer surface 20 and the bottom surface 33 are both typically v-shaped surfaces. Each surface is typically comprised of a left side and a right side. The left side and the right side are integrated at a surface apex, substantially in the middle of the surface, the surface apex being the v-shaped edge 31.

For example, the outer surface 20 left side extends from the back side 35 to a first v-shaped edge 31 and the outer surface right side extends from the front side 37 to the first v-shaped edge. Similarly, the bottom surface 33 left side extends from the back side to a second v-shaped edge and the bottom surface right side extends from the front side to the second v-shaped edge. The outer surface left side and right side typically extend from the top surface 34 to the bottom surface. The bottom surface left side and right side extend from the stirrer blade inner surface 40 to the outer surface.

### One Method of Using a Food Contents Stirrer to Mix at Least Partially Liquefied Food Contents.

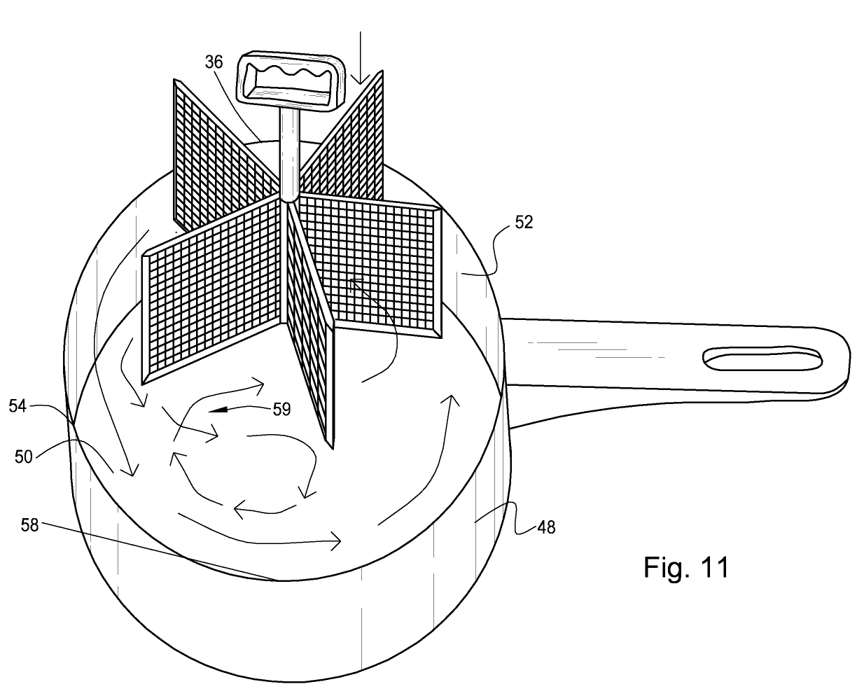

With particular reference to FIG. 11, a method to mix at least partially liquefied food contents is described herein. Initially, a user selects cookware 48 that is appropriate for the amount and the type of partially liquefied food contents the user wishes to mix. Typically, in the current method, a user selects cookware large enough to hold all the food contents in a manner that will not spill the food contents during the stirring process. Additional factors a user typically considers when determining the appropriate cookware to use is the type of food contents to be mixed and the manner in which the food contents will be prepared.

In order to determine the correct size of the cookware 48 that should be selected, many users review the recipe or measure the ingredients prior to selecting the cookware. Many times, upon reviewing the recipe or measuring the ingredients, a user may determine the size of the cookware that is needed. For example, if the amount of food contents is relatively small, small to medium size cookware may be selected. Many times, a recipe will provide the correct cookware size for the user to implement in the cooking process.

Once the appropriate cookware is selected, food contents are placed within the cookware 48. Once again, a user should consult the recipe to determine the correct order, if any, the user should take in placing the contents within the cookware. Many times, the food contents are required to be placed within cookware in separate and distinct groupings, between heat application and stirring cycles. For example, many recipes simply call for water to be placed within the cookware and heated to a boiling or near boiling temperature prior to other ingredients being placed within the heated water.

In the current method, once the appropriate ingredients are placed within the cookware 48, heat is typically applied to the mixture. However, in alternative methods, heat is not applied to the food contents. In the present method where heat is applied to the ingredients, heat is typically supplied through a stovetop heat application device, such as, but not limited to, a stovetop burner. The typical stovetop burner contains a substantially flat surface to set the cookware upon, with the heat being supplied to or around the flat surface. For example, one type of a stovetop burner is an open-flame gas stove having a wrought-iron flat surface that allows the open flame to reach the cookware through holes in the flat surface. However, other type of stovetop burners such as electric burners or biofuel burners may be used.

Whatever type of stove (also called a range) is used, the cookware 48 is typically placed on top of the substantially flat surface, with the heating element being located under the substantially flat surface. As stated, the substantially flat surface is adapted to allow the heat typically located below the substantially flat surface to pass to the cookware placed on top of the surface. Depending on the recipe, the heat may be supplied to the cookware prior to, during, or after the ingredients are placed within the cookware.

Upon placing the food contents into the cookware 48 and applying heat to the cookware, if the user is using a coupled-blade food contents stirrer 10 as opposed to an integrated blade food contents stirrer 10, the user determines what the number and placement of the stirrer blades 16 on the stirrer should be. Upon determining the number and placement of the stirrer blades, the user then couples the blades to the stem 14. For example, in an initially thick liquid, the user may only attach 3 blades, with large mesh spacing, in every other slot on the stem bottom portion.

In alternative methods, after the user couples an initial number of stirrer blades 16 to the food contents stirrer 10, the user may decouple blades or attach additional blades throughout the mixing process. Whenever blades are coupled to the stem bottom portion of the typical embodiment, the blades are typically also locked into position through a locking device, such as, but not limited to, a latch. Additionally, the user may wish to couple different types of blades at different stem slot 38 positions in the food contents stirrer. For example, a user may wish to attach stirrer blades with 1 inch spaces between the mesh at three of the slots, and attach stirrer blades with 1/16 inch spaces between the mesh at the other three slots. After stirring the mixture for a certain amount of time, the user may detach some stirrer blades or attach additional stirrer blades.

When the recipe calls for mixing the ingredients of the partially liquefied food contents, or if the user is not using a recipe and determines the food contents are required to be mixed, the food contents stirrer 10 is placed into the cookware 48. Typically, the user grips the handle 12 in order to keep hold of the stirrer. In the typical method, upon placing the stirrer into the mixture, the user places one or more of the bottom surfaces 33 of the stirrer blades 16 onto the inner bottom surface 50 of the cookware. The stirrer blade bottom surface is typically placed flush with the inner bottom surface of the cookware such that the majority of the length of at least one bottom surface v-shaped edge 31 comes into contact with the bottom surface.

If the user is using a typical food contents stirrer 10, as described herein, the food contents stirrer typically has more than one stirrer blade 16, with the v-shaped edge 31 of each stirrer blade bottom surface 33 being parallel to a single plane. Therefore, by placing one of the stirrer blade bottom surfaces substantially flush with the inside bottom surface 50 of the cookware 48, multiple stirrer blade bottom surface v-shaped edges are typically placed flush on the inside bottom surface of the cookware.

In the particular method, when at least one stirrer blade bottom surface 33 v-shaped edge 31 is placed flush with the cookware bottom surface 50, the user moves one or more stirrer blade outer surfaces 20 to a substantially flush position with an inner side surface 52 of the cookware. Typically, a user will place the v-shaped edge 31 of the outer surface substantially flush against the inner side surface of the cookware. Once at least one v-shaped edge is placed substantially flush with the inner side and inner bottom surfaces of the cookware, the user begins to move the stirrer in a substantially counter-clockwise motion.

When the counter-clockwise motion is begun in the particular method, the user ensures that a v-shaped edge 31 is kept generally flush with the inner bottom surface 50 and the inner side surface 52 of the cookware 48. Typically, a user ensures that a v-shaped edge of the stirrer 10 is kept flush with both inner surfaces of the cookware by applying pressure in a downward and outward motion during the movement of the stirrer.

In the current method, as the user is applying pressure downwardly and outwardly to the stirrer to ensure generally flush v-shaped edge 31 contact with the inner surfaces of the cookware 48, the counter-clockwise movement of the food contents stirrer follows the one or more inner side surfaces 52 of the cookware. As most cookware used in the current method is of a generally circular cross-section, as the user moves the food contents stirrer in the counter-clockwise motion, the v-shaped edges of the food contents stirrer typically easily remain generally flush with the inner surfaces of the cookware without a great amount of pressure. However, if the cookware cross section is rectangular or of another geometric design, the user may need to apply a greater amount of pressure in the counter-clockwise motion in order to ensure mixture is appropriately stirred.

Upon completion of one full counter-clockwise rotation, or nearly one full counter-clockwise rotation, while ensuring that the v-shaped edges 31 are flush with the inner surfaces of the cookware 48, the user begins a first figure-eight rotation. To begin the first figure-eight rotation, at the end of the counter-clockwise rotation, the user moves the food contents stirrer gradually away from the inside side surface 52 of the cookware as the user is still moving the stirrer generally in a counter-clockwise manner.

As the user continues to move the stirrer 10 away from the top 56 of the cookware in continuing the general counter-clockwise rotation, as the stirrer reaches a location at or near the mid-way point between the top 56 of the cookware 48 and the middle 54 of the cookware, the user gradually stops the counter-clockwise rotation and begins to move the stirrer towards the bottom 58 of the cookware and then towards the center 59 of the cookware, in a generally diagonal motion.

As the stirrer moves in a general diagonal motion generally through the center 59 of the cookware 48 from the upper left quadrant of the cookware to the lower right quadrant of the cookware, at generally the mid-way point between the middle 54 of the cookware and the bottom of the cookware 58, the user begins to move the stirrer in a generally clockwise direction. During the clockwise rotation, typically at least one outer surface 20 v-shaped edge 31 comes into contact with the inner surface 52 of the cookware. The user typically ensures that the outer surface v-shaped edge of the food contents stirrer 10 is generally flush with the cookware inner surface.

As the stirrer 10 is moved in a generally clockwise direction, at or near the bottom of the cookware during the first figure eight rotation the user gradually begins to move the one or more outer surfaces 20 of the food contents stirrer 10 away from the inner side surface 52 of the cookware. The stirrer is still generally moved in a clockwise direction as the outer surface is gradually moved farther away from the inner side surface of the cookware. When the stirrer is generally half-way between the bottom 58 and the middle 54 of the cookware, the user begins to move the stirrer towards the center 59 of the cookware in a generally diagonal direction.

As the stirrer 10 passes the center 59 of the cookware while moving in a generally diagonal direction from the lower left cookware quadrant to the upper right cookware quadrant and reaches a position generally between the middle 54 of the cookware 48 and the top 56 of the cookware, the user once again begins to move the stirrer in a counter-clockwise direction. At a point at or bear the top of the cookware, the outer surface 20 v-shaped edge 31 is once again placed substantially flush with the inner side surface 52 of the cookware.

At this point, the user begins to implement the counter clockwise rotation, keeping the v-shaped edge 31 of the outer surface 22 substantially flush with the inner side surface 52 of the cookware 48, as described herein. The counter-clockwise motion is alternated with the first figure-eight rotation until the mixture is adequately stirred, producing an adequately thick liquid, either by dissolving all thickening agents or through reduction, as well as keeping the mixture from burning. In alternative methods, the counter-clockwise rotation is not alternated with a first figure-eight rotation after every counter-clockwise rotation, but is alternative with a first figure-eight rotation after two, three, or more counter-clockwise rotations.

In an alternative method, a clockwise rotation may be used in place of one or more of the counter-clockwise rotations described herein. For example, the user may implement an initial clockwise rotation, perform a first figure-eight rotation as described herein, and then alternate counter-clockwise rotations with the first figure eight rotations thereafter. Or, any other clockwise/first figure eight/counter-clockwise rotation may be implemented.

In alternative methods, a second figure eight rotation may be used instead of, or in addition to, the first figure-eight rotation. In the second figure eight rotation, the user performs substantially the same functions as the first figure-eight rotation, starting from the top 56 of the cookware 48. However, the second figure is essentially a mirror image of the first figure-eight rotation wherein in the second figure eight rotation, all clockwise movements as described in the first-figure eight rotation are counter-clockwise movements, and vice versa. Additionally, the diagonal movements of the stirrer are from the top right quadrant of the cookware to the lower left quadrant of the cookware and from the lower right quadrant of the cookware to the upper left quadrant of the cookware, respectively. In such an alternative method implementing a second figure eight rotation, one or more second figure eight rotations may be used.

Additional alternative methods may implement a motorized stirrer. In a motorized stirrer, the user would engage to motor upon placing the stirrer into the food contents and disengage the motor when the food contents are adequately mixed.

### ALTERNATIVE EMBODIMENTS AND OTHER VARIATIONS

The embodiments of the food contents stirrer as illustrated in the accompanying figures and described above are merely exemplary and are not meant to limit the scope of the invention. It is to be appreciated that numerous variations to the invention have been contemplated as would be obvious to one of ordinary skill in the art with the benefit of this disclosure. For instance, the embodiments are described herein primarily in relation to a manually operated food contents stirrer. It is appreciated, however, that industrial variations may be implemented for stirring large amounts of food contents, or even for stirring industrial materials.

I claim:

1) A stirrer for food contents, the stirrer comprising:
a handle;
at least one stem, the stem being a generally cylindrical shaft integrated to the handle and including a center portion; and
one or more stirrer blades, the stirrer blade being integrated to the stem center portion and including at least one mesh surface and at least one “v-shaped” edge.

2) The stirrer of claim 1 wherein,
the stirrer blade being generally rectangular and further comprising a bottom surface, an outer surface, and a mesh interior;
the bottom surface being generally perpendicularly oriented relative to the stem longitudinal axis and having a first v-shaped edge;
the outer surface being generally parallelly oriented relative to the stem longitudinal axis and having a second v-shaped edge.

3) The stirrer of claim 2 further including:
an outer surface left side and an outer surface right side;
the outer surface left side and the outer surface right side being integrated together at an outer surface apex located substantially in the middle of the outer surface, the outer surface apex being the v-shaped edge;
the outer surface left side having a left side edge and the outer surface right side having a right side edge; and
a bottom surface left side and a bottom surface right side;
the bottom surface left side and the bottom surface right side being integrated together at a bottom surface apex located substantially in the middle of the bottom surface, the bottom surface apex being the v-shaped edge;
the bottom surface left side having a left side edge and the bottom surface right side having a right side edge.

4) The stirrer of claim 3 wherein,
the outer surface left side edge, the bottom surface left side edge, the outer surface right side edge, and the bottom surface right side edge being integrated to the mesh interior, the mesh interior being generally parallelly oriented relative to the stem longitudinal axis.

5) The stirrer of claim 2 wherein, the one or more stirrer blades comprises 6 stirrer blades, each stirrer blade being integrated to the stem at a blade inner surface, the circumferential distance between each stirrer blade inner surface being substantially equal.

6) The stirrer of claim 5 wherein,
the mesh surface is adapted for mixing at least partially liquefied food contents;
the bottom surface and the outer surface being comprised of resilient elastomeric material adapted to scrape and dislodge food fixedly attached to the inside surface of cookware.

7) The stirrer of claim 6, wherein, the mesh surface being comprised of a generally rigid heat-resistant material adapted to break apart lumps of a thickening agent.

8) A stirrer device for stirring food contents, the stirrer comprising:
a handle;
a stem, the stem being coupled to the handle and including at least one slot;
one or more blades, the blade including at least one meshed surface, one ore more v-shaped edges, and a flange; and
wherein the slot is adapted to receive a flange therein.

9) The stirrer of claim 8 wherein,
the mesh surface being comprised of a generally rigid heat-resistant material adapted for use with at least partially liquefied food contents; and
the one or more v-shaped edges being comprised of a generally elastomeric heat-resistant material adapted to substantially dislodge any food fixedly attached to the inner surface of the cookware.

10) The stirrer of claim 9 wherein,
the mesh surface being at least a partially detachable mesh surface;
the one or more blades being six generally rectangular blades; and
the one or more v-shaped edges being a first v-shaped edge and a second v-shaped edge, the first v-shaped edge being a bottom edge and the second v-shaped edge being an outer edge.

11) The stirrer of claim 10 wherein
the stem includes 6 slots;
the one or more blades being 6 blades; and
each of the 6 slots being adapted to receive at least one of the 6 blades therein.

12) A method for stirring food contents, the method comprising:
placing a food contents stirrer into cookware containing food contents;
the cookware being placed on a heat source;
the food contents stirrer comprising one or more stirrer blades, the one or more stirrer blades having at least one mesh surface, one or more v-shaped edges, and a flange, the v-shaped edge adapted to dislodge fixedly attached food from an inner surface of cookware; and
moving the stirrer in a circular direction and a figure-8 motion around the cookware.

13) The method of claim 12 further comprising:
placing at least one v-shaped edge substantially flush with an inner bottom surface of the cookware;
placing at least one v-shaped edge substantially flush with an inner side surface of the cookware; and
dislodging food fixedly attached to the inner side surface of the cookware and the inner bottom surface of the cookware while moving the stirrer in the counter-clockwise direction and the first figure-8 direction.

14) The method of claim 13 further comprising:
applying generally downward pressure to the v-shaped edge flush with the inner bottom surface of the cookware; and
applying generally outward pressure to the v-shaped edge flush with the inner side surface of the cookware.

15) The method of claim 12 further comprising:
moving the stirrer in a second figure-8 direction; and
moving the stirrer in a clockwise direction.

16) The method of claim 15, further comprising:
placing at least one v-shaped edge substantially flush with the inner bottom surface of the cookware;
placing at least one v-shaped edge substantially flush with an inner side surface of the cookware;
dislodging food fixedly attached to the inner side surface of the cookware and the inner bottom surface of the cookware while moving the stirrer in one or both of counter-clockwise and clockwise directions; and
dislodging food fixedly attached to the inner side surface of the cookware and the inner bottom surface of the cookware while moving the stirrer in one or both of the first and the second figure-8 directions.

17) The method of claim 12 wherein, the food contents stirrer further comprises a stem, the stem having one or more slots, the stem slots being adapted to receive the stirrer blade flanges, and further comprising:
coupling the stirrer blades to the stem by sliding at least one stirrer blade flange into a stem slot.

18) The method of claim 17 further comprising detaching at least one stirrer blade from the stem.

19) The method of claim 12 wherein, the food contents stirrer further comprises a motor, the motor adapted to move the stirrer blades, and further comprising:
turning on the motor; and
turning off the motor when the food contents are adequately mixed.

20) The method of claim 12 further comprising:
removing the food contents stirrer from the cookware; and
removing cookware from the heat source
